(19) United States
(12) Patent Application Publication
(10) Pub. No.: US 2011/0291382 A1
(43) Pub. Date: Dec. 1, 2011

(54) REAR SUSPENSION FOR A TWO-WHEEL VEHICLE

(76) Inventor: Pierre-Geoffroy Plantet, Audrieu (FR)

(21) Appl. No.: 13/123,224

(22) PCT Filed: Oct. 9, 2009
(86) PCT No.: PCT/EP09/63225

§ 371 Date: Aug. 3, 2011

(30) Foreign Application Priority Data
Oct. 9, 2008 (FR) 0856838

(51) Int. Cl. B62K 3/00

(52) U.S. Cl. 280/284

(57) ABSTRACT

The invention relates to a rear suspension for a vehicle such as a bicycle, a motorcycle, or the like, which comprises a chassis referred to as a frame (1), a swinging arm (12) hinged to the frame (1) and supporting the axle (14) of the hub of a driving wheel (15), and a shock absorber (27) having ends respectively connected to the frame (1) and the swinging arm (12), the driving torque being transmitted to the driving wheel by a transmission means, and a crankset housing (16) hinged to the frame (1) by a first hinge means (19) interacting with a second hinge means (22) hinged to the swinging arm (12). The suspension is characterised in that the rotation axis (21) between the first hinge means (19) and the second hinge means (22), the rotation axis (23) between the second hinge means (22) and the swinging arm (12), and the rotation axis (13) of the swinging arm (12) relative to the frame (1) are substantially aligned when the bicycle is in the so-called SAG static balance position.

### FIELD OF THE INVENTION

The present invention relates to a rear suspension for a vehicle such as a bicycle, a motorcycle or the like, of the type comprising a chassis, a swinging arm integral with the frame and a shock absorber the ends of which are integral respectively with the frame and the swinging arm, said suspension producing an effect called anti-bob.

### BACKGROUND OF THE INVENTION

All-terrain bicycles, called ATBs, are known, the rear suspension of which is constituted by a swinging arm hinged at the level of the lower part of the seat tube and cooperating with a shock absorber. Said swinging arm pivots about a fixed axis parallel to the axis of the drive sprocket which is borne by the crankset housing positioned at the bottom end of the frame, i.e. at the intersection of the down tube and the seat tube of the latter.

Moreover, the ends of the shock absorber are integral with the swinging arm and respectively with the top tube connecting the seat tube to the fork of the bicycle or an intermediate tube extending overall from the crankset housing to the top tube, said seat tube being interrupted to allow the shock absorber to pass.

Under the action of an energetic pedal stroke, such as a pedal stroke to restart the bicycle or when the cyclist takes the position called riding out of the saddle, standing on the pedals, this type of rear suspension causes a bobbing effect which results in a cyclic sinking of the suspension even on a perfectly even ground.

This type of rear suspension therefore has the drawback of dissipating part of the driving torque provided by the cyclist into the shock absorber instead of contributing to driving the bicycle.

In order to remedy this drawback, a large number of rear suspensions have already been devised. This is the case in particular in American patent application US2002/0109332, U.S. Pat. No. 5,899,480, U.S. Pat. No. 5,678,837, U.S. Pat. No. 5,509,679 or European patent applications EP1363831, EP1781530 or EP1026073 in particular.

These rear suspensions are generally constituted by a swinging arm hinged to the seat tube and/or to the down tube of the frame by means of two connecting rods or the like, said swinging arm or at least one of the connecting rods cooperating with a shock absorber. Said swinging arm thus pivots about a mobile virtual pivot point, also called instant centre of rotation, which corresponds to the intersection of the straight lines passing through the respective axes of the connecting rods or at a point located between the axes of the connecting rods if the latter extend parallel to each other. This is the case in American patent application US2002/0109332, for example, which describes such a rear suspension for a bicycle.

Some of these suspensions have the drawback of producing an effect called “kick back” and/or a bobbing effect which results in a cyclic sinking of the suspension even on a perfectly even ground, thus dissipating part of the driving torque provided by the cyclist into the shock absorber instead of contributing to driving the bicycle.

Moreover, the position and orientation of the connecting rods require the geometry of the frame to be adapted such that the driving position and/or the rigidity of the frame and/or the driveability are affected thereby.

### BRIEF DESCRIPTION OF THE INVENTION

One of the aims of the invention is therefore to remedy all of these drawbacks by proposing a rear suspension that has a simple design, is inexpensive and does not cause bobbing or a “kick back” phenomenon.

To this end, and according to the invention, a rear suspension is proposed for a vehicle such as a bicycle, a motorbike, or the like, of the type comprising a chassis called a frame, a swinging arm hinged to the frame bearing the axle of the hub of a drive wheel and a shock absorber the ends of which are integral respectively with the chassis and the swinging arm, the driving torque being transmitted to the drive wheel by transmission means, and a crankset housing hinged to the frame by a first hinge means cooperating with a second hinge means hinged to the swinging arm; said suspension is remarkable for the fact that the rotation axis between the first and the second hinge means, the rotation axis between the second hinge means and the swinging arm in relation to the frame, and the rotation axis of the swinging arm in relation to the frame are substantially aligned when the bicycle is in the static balance position (SAG).

Preferably, said axes are aligned overall on a substantially horizontal straight line.

The first and second hinge means consist respectively of a first and second connecting rod.

Moreover, the first connecting rod is mounted free in rotation in its central part around an axle integral with the frame, the crankset housing being integral with one end of the first connecting rod and the opposite end of said first connecting rod being hinged about a rotation axis to one of the ends of the second connecting rod, the opposite end of the second connecting rod being hinged around an axle integral with the swinging arm.

Preferably, the first connecting rod extends substantially vertically and the second connecting rod extends substantially horizontally in the static balance position.

Moreover, the axis of the crankset housing and the rotation axis of the first connecting rod in relation to the frame are advantageously positioned on a vertical straight line when the bicycle is in the static balance position in order to accommodate the inertial effects of the body on the frame.

Moreover, the distance separating the axis of the hub of the rear wheel and the rotation axis of the swinging arm in relation to the frame is substantially equal to 4 times the different in height between the axis of the hub of the rear wheel and the rotation axis of the swinging arm in relation to the frame.

### BRIEF DESCRIPTION OF THE DRAWINGS

Other advantages and characteristics will be better understood from the following description of several embodiment variants, given by way of non-limitative examples, of the rear suspension according to the invention, from the attached drawings in which:

FIG. 1 is a side view of a bicycle equipped with a rear suspension according to the invention,

FIG. 2 is a diagrammatic representation of the bicycle equipped with the suspension according to the invention shown in FIG. 1, only the frame and the rear swinging arm being shown,

FIG. 3 is a graphic representation of the curve of the torque applied to the swinging arm as a function of the travel of the rear wheel of the suspension according to the invention,

FIG. 4 is a graphic representation comparing the chain length as a function of the sinking of a suspension according to the invention and a single pivot suspension of the prior art,

FIG. 5 is a graphic representation of the percentage increase in the length of the chain line as a function of the sinking of a suspension according to the invention and a single pivot suspension of the prior art,

FIG. 6 is a diagrammatic representation of the bicycle equipped with an embodiment variant of the suspension according to the invention, only the frame and the rear swinging arm being shown,

FIG. 7 is a diagrammatic representation of the bicycle equipped with a first embodiment variant of the suspension according to the invention, only the frame and the rear swinging arm being shown,

FIG. 8 is a diagrammatic representation of the bicycle equipped with a second embodiment variant of the suspension according to the invention, only the frame and the rear swinging arm being shown,

FIG. 9 is a diagrammatic representation of the bicycle equipped with a third embodiment variant of the suspension according to the invention, only the frame and the rear swinging arm being shown,

FIG. 10 is a diagrammatic representation of the bicycle equipped with a fourth embodiment variant of the suspension according to the invention, only the frame and the rear swinging arm being shown,

FIG. 11 is a diagrammatic representation of the bicycle equipped with a final embodiment variant of the suspension according to the invention, only the frame and the rear swinging arm being shown,

### DETAILED DESCRIPTION OF THE INVENTION

A rear suspension of a bicycle of the all terrain bicycle (ATB) type will be described below by way of non-limitative example. However, the rear suspension according to the invention could be adapted to any other vehicle without departing thereby from the framework of the invention.

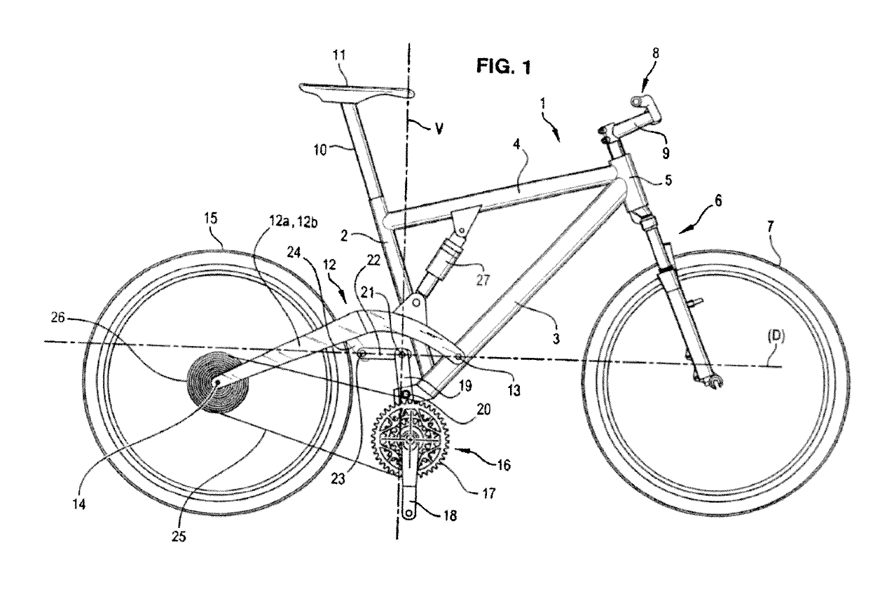

With reference to FIG. 1, the ATB which is shown in the static balance position comprises a chassis 1 called a triangulated frame constituted by a seat tube 2 vertical overall, a down tube 3 assembled by welding to the lower end of the seat tube 2 and a top tube 4 the ends of which are assembled by welding to the upper end of the seat tube 2 and respectively to a fork tube 5 vertical overall, the down tube 3 being, moreover, joined to said fork tube 5, also by welding. This fork tube 5 holds a fork 6 of the telescopic type, bearing at its lower end the axle of the hub of the front wheel 7 of the ATB. A handlebar 8 is joined in standard manner to the distal end of a stem 9 integral with the upper end of the fork 6 to provide the steering of the ATB. The seat tube 2 is able to hold a seat post 10 comprising, at its upper end, a seat 11 on which the cyclist takes position.

By static balance position is meant the initial sinking, called “SAG”, of the front and/or rear suspensions under load, i.e. when a cyclist of average weight takes position on the bicycle without touching the ground and without moving.

Said ATB moreover comprises a single swinging arm 12 constituted by two curved units 12a, 12b extending on both sides of the central plane of the frame 1, the concavity of the curved units 12a, 12b being oriented towards the ground. Said units 12a, 12b are linked by one or more spacers, not shown in FIG. 1. The proximal end of the swinging arm 12 is hinged to the frame 1 about a rotation axis 13 positioned at the lower end of the down tube 3, i.e. close to the intersection of the down tube 3 and said seat tube 2. The distal end of said swinging arm 12 bears the axle 14 of the hub of the rear drive wheel 15.

Moreover, said ATB comprises a crankset housing 16 bearing, in standard manner, the axle of the drive sprockets 17 jointly called chainrings, the axes of rotation of which are coaxial. Pedals 18 are integral with the axle of the drive sprockets 17 on both sides of the frame 1 of the ATB. Said crankset housing 16 is integral with the lower end of a first connecting rod 19 extending vertically overall. By substantially vertically is meant a position of the connecting rod 19 forming an angle with the vertical comprised between −30 and +30°. This first connecting rod 19 is substantially straight and it is hinged in its central part around an axle 20 integral with the frame 1, and more precisely around an axle 20 integral with the lower end of the down tube 3. The opposite end of said first connecting rod 19 is hinged about a rotation axis 21 to one of the ends of a second connecting rod 22, the opposite end of said second connecting rod 22 being hinged around an axle 23 integral with a leg 24 welded in the central part of the swinging arm 12, below the latter. Said second connecting rod 22 extends substantially horizontally in the static balance position. By substantially horizontally is meant a position of the connecting rod 22 forming an angle with the horizontal comprised between −30 and +30°.

It is clear that the connecting rods 19 and/or 22 will be able to be substituted by any equivalent hinge means known to a person skilled in the art, such as eccentrics or the like.

It will be observed that the axis of the crankset housing 16 and the rotation axis 20 of the first connecting rod 19 in relation to the frame 1 are positioned on a vertical straight line (V) when the bicycle is in the static balance position in order to accommodate the inertial effects of the body of the cyclist on the frame 1.

In standard manner, said rear wheel 15 is driven in rotation by a power transmission chain 25 extending between the drive pinion 17 of the crankset housing 16 and a driven pinion 26 borne by the axle 14 of the hub of the rear drive wheel 15, when the cyclist pedals.

It will also be noted that the rotation axis 21 between the first 19 and the second 22 connecting rod, the rotation axis 13 of the swinging arm 12 in relation to the frame 1 and the rotation axis 23 between the second connecting rod 22 and the swinging arm 12 are substantially aligned when the bicycle is in the static balance position (SAG). In this particular embodiment example, said axes are aligned overall on a substantially horizontal straight line (D).

Moreover, the distance separating the axle 14 of the hub of the rear wheel 15 and the rotation axis 13 of the swinging arm 12 in relation to the frame 1 is substantially equal to 4 times the different in height between the axle 14 of the hub of the rear wheel 15 and the rotation axis 13 of the swinging arm 12 in relation to the frame 1.

Moreover, the ATB comprises a shock absorber 27 the ends of which are integral respectively with the top tube 4 of the frame 1 and the swinging arm 12.

The operation of the suspension according to the invention will now be explained with reference to FIGS. 1 to 3.

When a cyclist takes position on the ATB provided with the suspension according to the invention and pedals over flat ground, the axle 14 of the hub of the rear wheel is in the SAG position and the torque exerted by external forces at the level of the rotation axis 13 of the swinging arm 12 in relation to the frame 1 is zero, thus avoiding any sinking of the suspension, i.e. avoiding any occurrence of a bobbing phenomenon.

Said external forces consist of forces induced in the connecting rods 19 and 22 and in the rear wheel 15, the loads of the frame 1 on the swinging arm producing a zero torque at the level of the rotation axis 13 of the swinging arm in relation to the frame by virtue of the pin which connects these two parts.

When the rear wheel 15 encounters an obstacle, with reference to FIG. 3, the curve shows that, for a sinking of the upper suspension in “SAG”, the torque is positive, while the torque is negative when the suspension is unloaded such that, if the swinging arm 12 is not in its “SAG” position, it is brought back to it by the pedalling loads.

Moreover, it will be observed that, when the rear wheel encounters an obstacle, i.e. when the axle of the wheel is located above “SAG”, the crankset housing shifts slightly towards the front wheel, which produces a very slight increase in the chain tension which is imperceptible to the cyclist. The latter therefore does not have an impression of “kick-back”, contrary to the devices of the prior art.

In fact, with reference to FIG. 4, the suspension according to the invention and a standard suspension of the single pivot type are compared in terms of evolution of the length of the chain line as a function of the sinking. As a single pivot suspension, a configuration will be taken which has the pivot point of the swinging arm in relation to the front triangle at the same place as the suspension according to the invention.

On the other hand, the crankset housing does not move in relation to the front triangle, i.e. in relation to the frame 1 and it is taken in the same place as that of the suspension according to the invention when it is in SAG. Moreover, the elongation of the length of the chain line was calculated with the following dimensions: length of the swinging arm 12 of approximately 540 mm, length of the first connecting rod 19 of approximately 108 mm, length of the second connecting rod 22 of approximately 105 mm, and a distance between the rotation axis 13 of the swinging arm 12 in relation to the frame 1 and the rotation axis 23 of the second connecting rod 22 in relation to the swinging arm 12 of approximately 200 mm.

Given that the crankset housing 16 of the suspension according to the invention moves forward slightly when the suspension sinks, the length of the chain line increases more than when the standard single pivot-type suspension sinks.

With reference to FIG. 5, which represents the increase in the chain length as a percentage of the suspension according to the invention in relation to a single pivot suspension as a function of the sinking, it appears that, over the first two centimeters of sinking of the suspension, this sinking range corresponding to the sinking range in which a bobbing phenomenon occurs in the suspensions of the prior art, the increase in the chain length is only approximately 7%. This small difference is imperceptible to a cyclist.

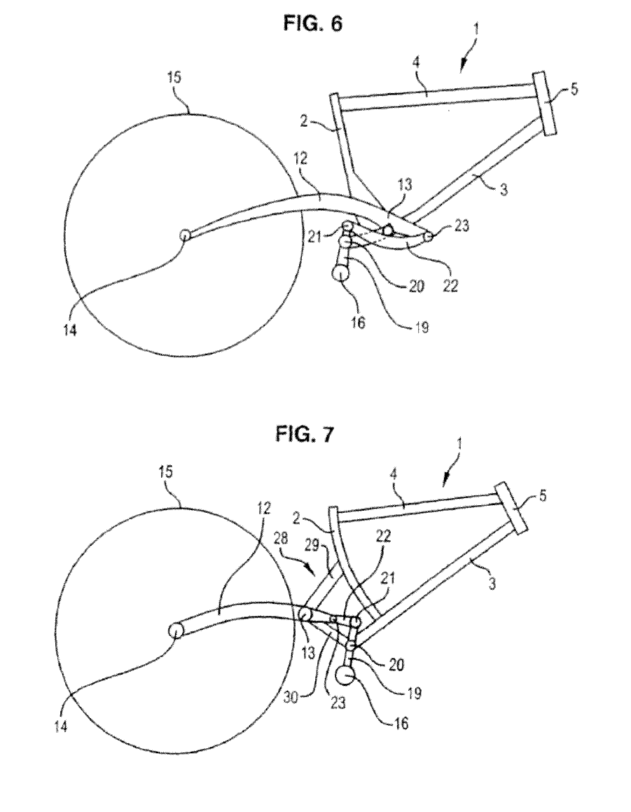

According to a first embodiment variant of the rear suspension according to the invention, with reference to FIG. 6, the latter comprises, in the same way as previously, a chassis 1 referred to as a triangulated frame, constituted by a seat tube 2, a down tube 3 and a top tube 4, a single swinging arm 12 hinged to the frame 1 about a rotation axis 13 and a crankset housing 16 integral with a first connecting rod 19 hinged around an axle 20 integral with the frame 1, said first connecting rod 19 being hinged about a rotation axis 21 to a second connecting rod 22 hinged around an axle 23 integral with the swinging arm 12.

This suspension differs from the previous one by the fact that the rotation axis 23 of the second connecting rod 22 is positioned in front of the rotation axis 13 of the swinging arm 12 in relation to the frame 1. In this embodiment example the second connecting rod 22 extends horizontally and has a slightly curved shape.

According to a second embodiment variant of the rear suspension according to the invention, with reference to FIG. 7, the latter comprises, in the same way as previously, a chassis 1 called a triangulated frame, constituted by a seat tube 2, a down tube 3 and a top tube 4, a single swinging arm 12 hinged to the frame 1 about a rotation axis 13 and a crankset housing 16 integral with a first connecting rod 19 hinged around an axle 20 integral with the frame 1, said first connecting rod 19 being hinged about a rotation axis 21 to a second connecting rod 22 hinged around an axle 23 integral with the swinging arm 12.

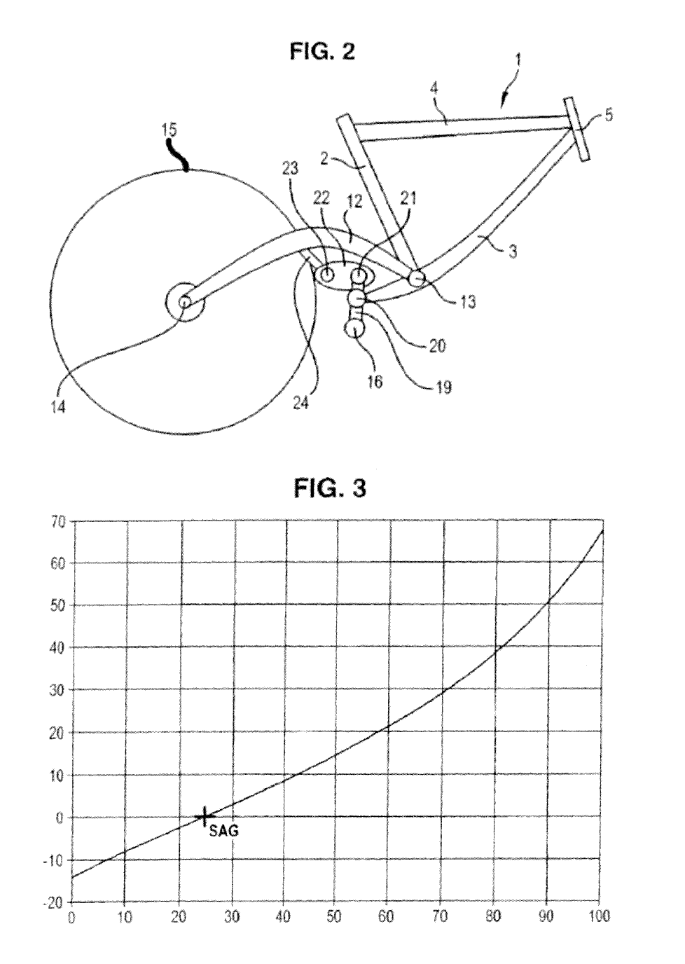

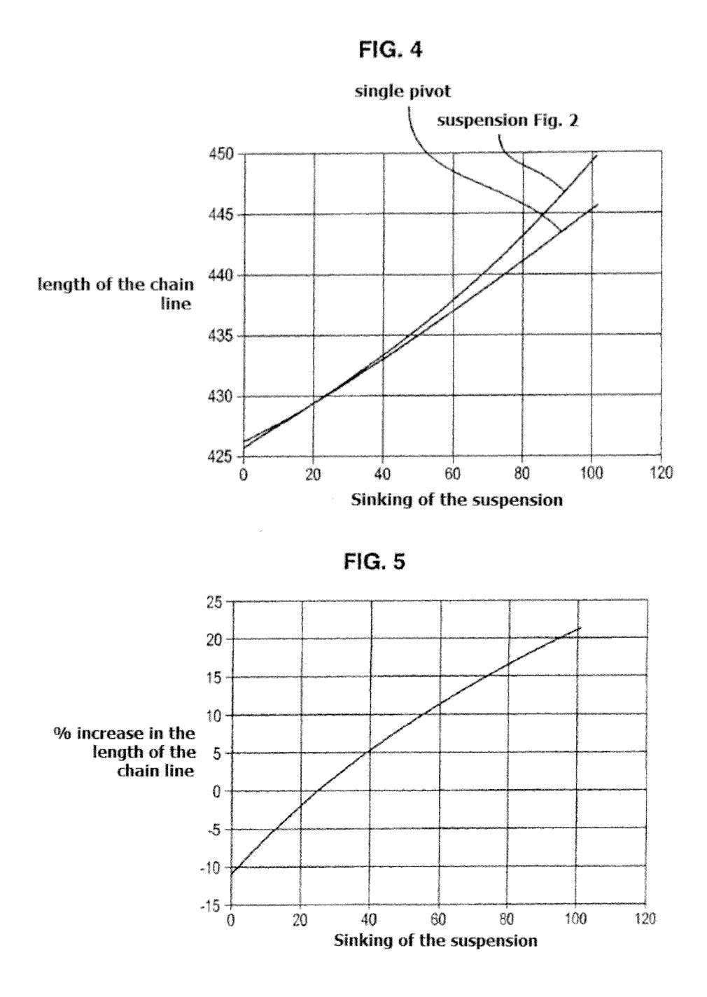

This suspension differs from the suspension shown in FIGS. 1 and 2 by the fact that, on the one hand, the rotation axis 13 of the swinging arm 12 is positioned behind the rotation axis 20 of the first connecting rod 19 in relation to the frame 1 and, on the other hand, the rotation axis 23 of the second connecting rod 22 is positioned in front of the rotation axis 13 of the swinging arm in relation to the frame 1. In order to produce this particular structure of the rear suspension according to the invention, the frame 1 comprises, in its rear part, a second triangle 28 constituted by tube segments 29 and 30.

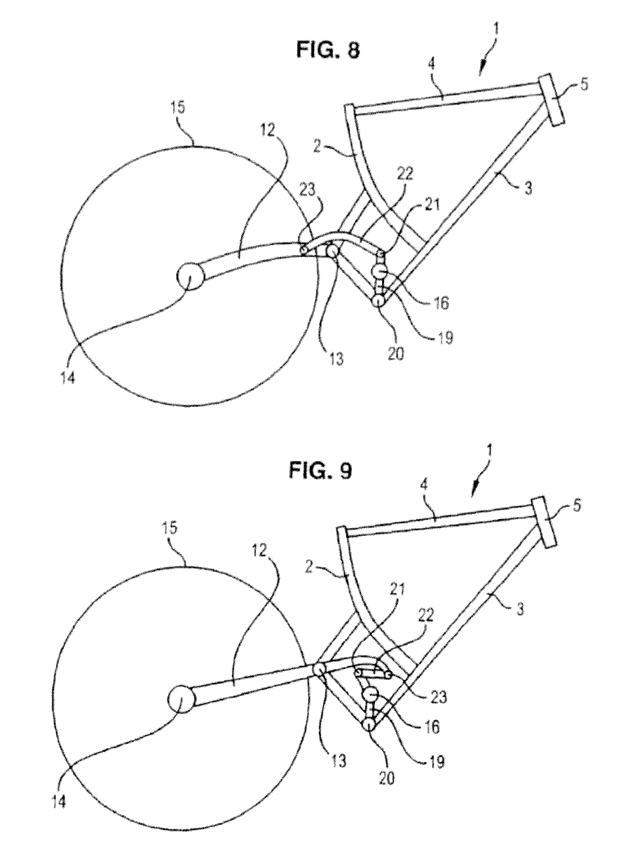

According to a third embodiment variant of the rear suspension according to the invention, with reference to FIG. 8, the latter comprises, in the same way as previously, a chassis 1 called a triangulated frame, constituted by a seat tube 2, a down tube 3 and a top tube 4, a single swinging arm 12 hinged to the frame 1 about a rotation axis 13 and a crankset housing 16 integral with a first connecting rod 19 hinged around an axle 20 integral with the frame 1, said first connecting rod 19 being hinged about a rotation axis 21 to a second connecting rod 22 hinged around an axle 23 integral with the swinging arm 12.

This suspension differs from the previous suspension shown in FIG. 7 by the fact that, on the one hand, the crankset housing 16 is positioned above the rotation axis 20 of the first connecting rod in relation to the frame 1 and, on the other hand, that the rotation axis 23 of the second connecting rod 22 is positioned behind the rotation axis 13 of the swinging arm in relation to the frame 1.

According to a fourth embodiment variant of the rear suspension according to the invention, with reference to FIG. 9, the latter comprises, in the same way as previously, a chassis 1 called a triangulated frame, constituted by a seat tube 2, a down tube 3 and a top tube 4, a single swinging arm 12 hinged to the frame 1 about a rotation axis 13 and a crankset housing 16 integral with a first connecting rod 19 hinged around an axle 20 integral with the frame 1, said first connecting rod 19 being hinged about a rotation axis 21 to a second connecting rod 22 hinged around an axle 23 integral with the swinging arm 12.

This suspension differs from the previous suspension shown in FIG. 8 by the fact that the rotation axis 23 of the second connecting rod 22 is positioned in front of the rotation axis 13 of the swinging arm in relation to the frame 1 and in front of the crankset housing 16.

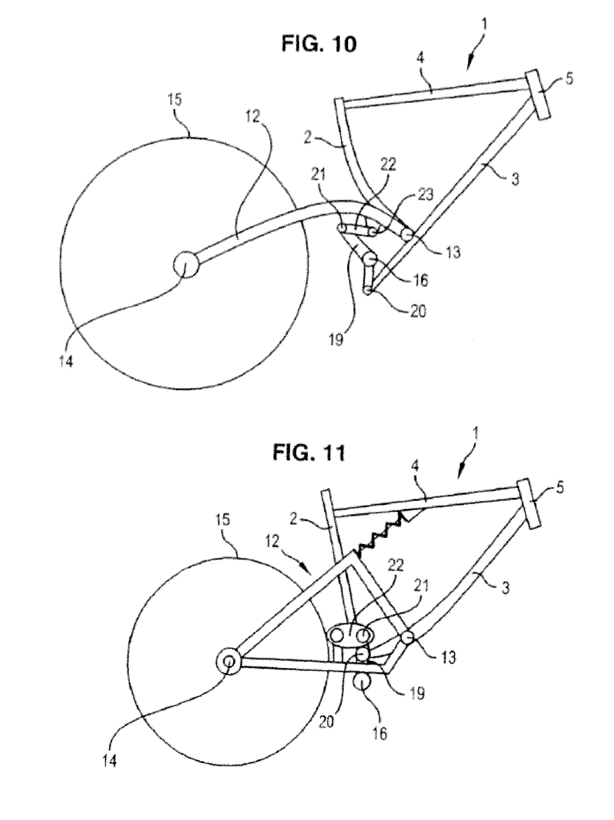

According to a fifth embodiment variant of the rear suspension according to the invention, with reference to FIG. 10, the latter comprises, in the same way as previously, a chassis 1 called a triangulated frame, constituted by a seat tube 2, a down tube 3 and a top tube 4, a single swinging arm 12 hinged to the frame 1 about a rotation axis 13 and a crankset housing 16 integral with a first connecting rod hinged around an axle 20 integral with the frame 1, said first connecting rod 19 being hinged about a rotation axis 21 to a second connecting rod 22 hinged around an axle 23 integral with the swinging arm 12.

This suspension differs from the suspension shown in FIGS. 1 and 2 by the fact that, on the one hand, the crankset housing 16 is positioned above the rotation axis 19 of the first connecting rod in relation to the frame 1 and, on the other hand, that the rotation axis 23 of the second connecting rod 22 is positioned in front of the rotation axis 21 of the first connecting rod 19 in relation to the second connecting rod 22.

According to a final embodiment variant of the rear suspension according to the invention, with reference to FIG. 11, the latter comprises, in the same way as previously, a chassis 1 called a triangulated frame, constituted by a seat tube 2, a down tube 3 and a top tube 4, a single swinging arm 12 hinged to the frame 1 about a rotation axis 13 and a crankset housing 16 integral with a first connecting rod 19 hinged around an axle 20 integral with the frame 1, said first connecting rod 19 being hinged about a rotation axis 21 to a second connecting rod 22 hinged around an axle 23 integral with the swinging arm 12.

This suspension differs from the suspension shown in FIGS. 1 and 2 by the fact that the single swinging arm 12 has been substituted with a triangular swinging arm 12.

It is clear that the frame 1 will be able to have any form, such as a triangular frame or a beam frame for example, and that the swinging arm will also be able to have any form, such as a single arm or a triangular arm for example, still without departing from the framework of the invention.

Moreover, it is very obvious that a person skilled in the art will easily be able to adapt the dimensions of the tubes of the frame 1, the swinging arm 12 and the connecting rods 19 and 22 as a function in particular of the size of the cyclist and of the intended use of the bicycle.

Finally, it will be understood that the examples just given are only particular illustrations that are in no way limiting as regards the fields of use of the invention.

1. Rear suspension for a vehicle such as a bicycle, a motorcycle, or the like, of the type comprising a chassis called a frame (1), a swinging arm (12) hinged to the frame (1) bearing the axle (14) of the hub of a drive wheel (15), a shock absorber (27) the ends of which are integral respectively with the frame (1) and the swinging arm (12), the driving torque being transmitted to the drive wheel by transmission means, and a crankset housing (16) hinged to the frame (1) by a first hinge means (19) cooperating with a second hinge means (22) hinged to the swinging arm (12); characterized in that the rotation axis (21) between the first (19) and the second (22) hinge means, the rotation axis (23) between the second hinge means (22) and the swinging arm (12), and the rotation axis (13) of the swinging arm (12) in relation to the frame (1) are substantially aligned when the bicycle is in the static balance position called SAG.

2. Suspension according to claim 1, characterized in that said axes (21, 23 and 13) are aligned overall on a substantially horizontal straight line.

3. Suspension according to any one of claims 1 or 2, characterized in that the first (19) and second (22) hinge means consist respectively of a first and second connecting rod (19, 22).

4. Suspension according to claim 3, characterized in that the first connecting rod (19) is mounted free in rotation in its central part around an axle (20) integral with the frame (1), the crankset housing (16) being integral with one end of the first connecting rod (19) and the opposite end of said first connecting rod (19) being hinged about a rotation axis (21) to one of the ends of the second connecting rod (22), the opposite end of the second connecting rod (22) being hinged around an axle (23) integral with the swinging arm (12).

5. Suspension according to any one of claims 3 or 4, characterized in that the first connecting rod (19) extends substantially vertically in the static balance position.

6. Suspension according to any one of claims 3 to 5, characterized in that the second connecting rod (22) extends substantially horizontally in the static balance position.

7. Suspension according to any one of claims 3 to 6, characterized in that the axle of the crankset housing (16) and the rotation axis (20) of the first connecting rod (19) in relation to the frame (1) are positioned on a vertical straight line when the bicycle is in the static balance position in order to accommodate the inertial effects of the body on the frame (1).

8. Suspension according to any one of claims 1 to 7, characterized in that the distance separating the axle (14) of the hub of the rear wheel (15) and the rotation axis (13) of the swinging arm (12) in relation to the frame (1) is substantially equal to 4 times the difference in height between the axle (14) of the hub of the rear wheel (15) and the rotation axis (13) of the swinging arm (15) in relation to the frame (1).
